(19) United States
(12) Patent Application Publication
(10) Pub. No.: US 2004/0000170 A1
(43) Pub. Date: Jan. 1, 2004

(54) Optical element molding apparatus

(75) Inventors: Shusaku Matsumura, Numazu-Shi (JP); Hirotaka Masaki, Mishima-Shi (JP)

Correspondence Address: PILLSBURY WINTHROP, LLP, P.O. BOX 10500, MCLEAN, VA, 22102, US

(73) Assignee: TOSHIBA KIKAI KABUSHIKI KAISHA, Tokyo-To (JP)

(21) Appl. No.: 10/461,460

(22) Filed: Jun. 16, 2003

(30) Foreign Application Priority Data
Jun. 27, 2002 (JP) 2002-188110
Apr. 11, 2003 (JP) 2003-107919

(51) Int. Cl. C03B 11/00

(52) U.S. Cl. 65/157; 65/305

(57) ABSTRACT

An optical element molding apparatus according to the present invention comprises a sealed molding chamber, a pair of molds arranged in the molding chamber, and a vacuum-pump means which vacuum-pumps an inside of the molding chamber. The vacuum-pump means includes a twist-groove-vacuum pump having a twisted groove on a surface of a rotor which is rotated at a high speed, and a rotary pump. The pair of molds are adapted to mold an optical element by press-molding an optical element material which is heated to a temperature higher than a transition point.

### BACKGROUND OF THE INVENTION

1. Field of the Invention

The present invention relates to an apparatus for molding an optical element by press-molding.

2. Description of Related Art

Manufacturing an optical element such as glass lens, which requires high precision, can generally be classified into two methods. One is a method of manufacturing an optical element by grinding and polishing, and the other is a method of manufacturing the same by reheat-pressing. A prevailing method of manufacturing an optical element is one in which a glass material is ground and polished to form an optical surface. However, to form a curved surface by grinding and polishing has many disadvantages. For example, more than ten steps are needed, and a considerable amount of glass ground powder is generated, which is harmful to an operator. Further, it is difficult for a grinding and polishing method to produce glass lenses on a large scale with the same precision in cases where the glass lens has a value-added aspheric optical surface.

On the other hand, in a reheat-pressing method, a glass material (a glass material previously divided into a predetermined size) formed by cooling a melted glass is heated and pressed to transfer a form of the mold to the glass material, so that an optical element such as an optical lens is manufactured. Such a method is advantageous in that only a single press-molding step is needed in forming a curved surface. Further, once a mold is formed, numerous molded items conforming to a precision of the mold can be manufactured.

Steps for reheat-pressing are generally as follows: a glass material is set between upper and lower molds, while a gas in a molding chamber containing the molds and the glass material is replaced with an inactive gas such as nitrogen gas in order to prevent an oxidation of the molds. Then, the molds and the glass material are heated with an infrared lamp (or a high frequency heating device). After reaching a predetermined temperature, the glass material is pressed by the upper and lower molds and finally cooled. A product is thus taken out therefrom.

When molding an optical element by the reheat-pressing method, the inactive gas may be trapped between the molds and the glass material depending on their forms, so that a defect called an air residue is generated on a surface of the molded optical element. Further, when oxygen remains in the molding chamber containing the molds and the glass material after replacing a gas in the molding chamber with an inactive gas, a problem may occur that the molds are oxidized by the remaining oxygen under a high temperature. To overcome these disadvantages, the molding chamber is conventionally depressurized and evacuated to discharge oxygen therein, while supplying a small amount of inactive gas to the inside of the molding chamber.

As shown in FIG. 2, a turbo-molecular pump 44 is combined with a rotary pump 46 to vacuum-pump the molding chamber. The turbo-molecular pump 44 includes therein, like a jet engine, a turbine having a rotor with a flap of an axial-flow-turbine type and a stator. The turbine is rotated at a high speed to discharge air. The rotary pump 46 includes a pair of rotors in a pump body thereof. The rotors are rotated in a small gap between the same and the pump body to push a gas from an intake port thereof to an exhaust port thereof. In decreasing a pressure in the molding chamber from an atmospheric pressure, a switch valve 42 as a switch point of a discharge line is disposed, whereby after the molding chamber is vacuum-pumped to some extent by the rotary pump 46, the turbo-molecular pump 44 further vacuumizes the molding chamber. In FIG. 2, the reference number 40 indicates an optical element molding apparatus, the reference number 41 indicates a vacuum gauge, and the reference numbers 43 and 45 respectively indicate vacuum valves.

Since an evacuation limitation of the rotary pump 46 is about 1 Pa, the rotary pump 46 should be switched to another vacuum pump when a higher vacuum degree is needed. Thus, the switch valve 42 as a switch point of a discharge line must be disposed. However, a disposition of the switch valve 42 of a discharge line provides such disadvantages that a constitution of a vacuum-pump means becomes complicated, and the turbine of the turbo-molecular pump 44 may be damaged by mistakenly operating the switching valve 42.

### SUMMARY OF THE INVENTION

An object of the present invention is to provide an optical element molding device which can solve the above disadvantages, and can reduce the pressure in a molding chamber without damaging a pump by mistakenly operating a switch point.

An optical element molding apparatus according to the present invention comprises: a sealed molding chamber; a pair of molds arranged in the molding chamber; and a vacuum-pump means which vacuum-pumps an inside of the molding chamber; wherein the vacuum-pump means includes a twist-groove-vacuum pump having a twisted groove on a surface of a rotor which is rotated at a high speed, and a rotary pump; and the pair of molds are adapted to mold an optical element by press-molding an optical element material which is heated to a temperature higher than a transition point.

According to the present invention, the twist-groove-vacuum pump and the rotary pump can be activated at the same time, whereby the molding chamber can be depressurized to a predetermined pressure in a short time.

In an optical element molding apparatus according to the present invention, the twist-groove-vacuum pump and the rotary pump may serially be connected to each other.

### BRIEF DESCRIPTION OF THE DRAWINGS

FIG. 1 is an overall structural view showing an embodiment of an optical element molding device according to the present invention; and

FIG. 2 is a view showing a structure of a vacuum-pump means of a conventional optical element molding device.

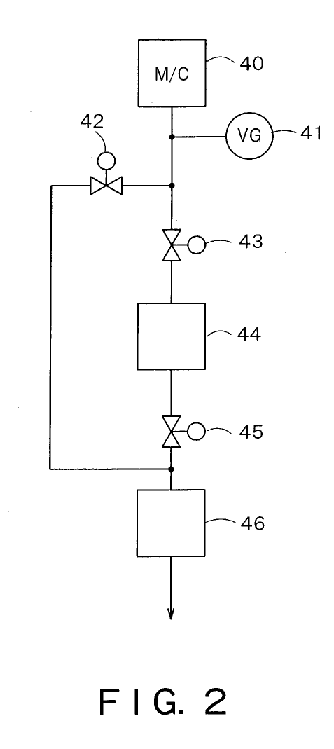

### DETAILED DESCRIPTION OF A PREFERRED EMBODIMENT OF THE INVENTION

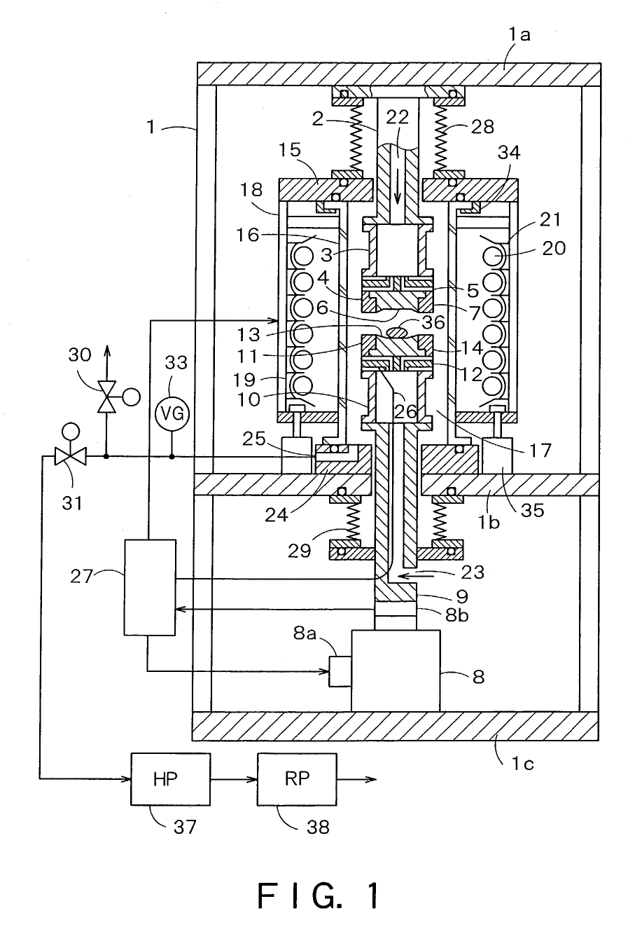

An embodiment of the present invention is described with reference to FIG. 1. FIG. 1 is an overall structural view showing a press-molding device for an optical element according to an embodiment of the present invention. An upper plate 1a is attached to an upper part of a frame 1. A securing shaft 2 downwardly extends from the upper plate 1a. The securing shaft 2 has at its lower end an upper mold assembly 4 disposed through a heat insulation tube 3 made of ceramics. The upper mold assembly 4 is composed of a die plate 5 made of metal, an upper mold 6 made of ceramics (or hard metal), and a securing die 7 which secures the upper mold 6 to the die plate 5 and forms a part of the mold.

A base 1c is disposed at the lower part of the frame 1. A screw jack 8 is disposed on the base 1c. A moving shaft 9 is attached to an upper part of the screw jack 8 through a load cell 8b. The screw jack 8 has a servomotor 8a as a driving source, and converts a rotational movement of the servomotor 8a to a linear one. The moving shaft 9 is opposed to the securing shaft 2, and is upwardly extended to pass through an intermediate plate 1b disposed on a middle stage of the frame 1 and an intermediate block 1d attached to an upper surface of the intermediate plate 1b. A lower mold assembly 11 is attached to an upper end of the moving shaft 9 through a heat insulation tube 10. The moving shaft 9 is vertically moved, with its position, speed and torque being controlled according to a program previously inputted in a control disk 27. The lower mold assembly 11 is composed of, as is the case with the upper mold assembly 4, a die plate 12 made of metal, a lower mold 13 made of ceramics (or hard metal), and a moving die 14 which secures the lower mold 13 to the die plate 12 and forms a part of the mold.

A bracket 15 is slidably attached around the securing shaft 2. The bracket 15 can be moved vertically by a driving device (not shown). A transparent silica tube 16 is attached to a lower surface of the bracket 15 such that the silica tube 16 surrounds a periphery of the upper mold assembly 4 and the lower mold assembly 11. The silica tube 16 has flanged portions at its upper and lower portions. An outer tube 18 is attached below the bracket 15 such that the outer tube 18 surrounds an outer periphery of the silica tube 16. The outer tube has a lamp unit 19 disposed along its inner wall. The lamp unit 19 includes an infrared lamp 20, a reflecting mirror 21 disposed rearward the infrared lamp 20 (on a side of the outer tube), and a water cooling pipe (not shown) for cooling the reflecting mirror 21. The lamp unit 19 radiant-heats the upper mold assembly 4 and the lower mold assembly 11 from outside the silica tube 16.

An upper end flange of the silica tube 16 is secured to the bracket 15 by a clamp 34. A contacting surface of the upper end flange of the silica tube 16 and the bracket 15 is sealed by an O-ring fitted in a lower surface of the bracket 15. A lower end flange of the silica tube 16 is pressed against an upper surface of an intermediate block 24. A contacting surface of the lower end flange of the silica tube 16 and the upper surface of the intermediate block 24 is sealed by an O-ring fitted in the upper surface of the intermediate block 24. Thus, in the silica tube 16, a molding chamber 17 is formed which shields the periphery of the upper mold assembly 4 and the lower mold assembly 11 from the outside.

The outer tube 18 is supported by the intermediate plate 1b through a movable clamp 35, in order not to damage the silica tube 16 when pressing the lower end flange of the silica tube 16 against the O-ring fitted in the upper surface of the intermediate block 24.

An extendable bellows 28 for an upper shaft is provided between the upper plate 1a and the bracket 15 so as to shield an upper side of the molding chamber 17 from the outside. An extendable bellows 29 for a lower shaft is provided between the intermediate plate 1b and an intermediate portion of the moving shaft 9 so as to shield a lower side of the molding chamber 17 from the outside.

In order to fill the molding chamber 17 with an inactive gas such as nitrogen gas, or to introduce therein a cooling gas for cooling the upper mold assembly 4 and the lower mold assembly 11, gas supply paths 22, 23 are respectively formed inside the securing shaft 2 and the moving shaft 9. For example, an inactive gas is supplied into the molding chamber 17 through a flow rate adjuster (not shown). The inactive gas supplied into the molding chamber 17 is discharged through a discharge port 25 formed in the intermediate block 24. Vacuum valves (not shown) are provided on the gas supply paths 22, 23 to prevent the inactive gas from flowing from the gas supply paths 22, 23 into the molding chamber 17 when vacuum-pumping the molding chamber 17.

A discharge path connected to the discharge port 25 is connected to a helical-groove-vacuum pump 37 (a twist-groove-vacuum pump) which serves as a vacuum-pump means. A vacuum gauge 33 and a vacuum valve 31 for vacuum-pumping are attached to the discharge path. Between a measuring position of the vacuum gauge 33 and a position where the vacuum valve 31 is located, the discharge path has a branch on which a vacuum valve 30 for discharging nitrogen gas is disposed. The helical-groove-vacuum pump 37 is serially connected to a rotary pump 38.

The helical-groove-vacuum pump 37 has a rotor, and a twisted groove disposed in the rotor. With a high-speed rotation of the rotor having such a groove therein, the helical-groove-vacuum pump 37 can realize a high vacuum. A thermo couple 26 is attached to the lower mold assembly 11.

An operation of an optical element molding device according to the present invention is described below. The helical-groove-vacuum pump 37 and the rotary pump 38 are activated, with the vacuum valve 31 for vacuum-pumping being closed. Then, a glass material 36 is set between the upper mold 6 and the lower mold 13 of the molding device. Thereafter, the bracket 15 is lowered to press the lower end flange of the silica tube 16 against the O-ring fitted in the upper surface of the intermediate block 24 by the movable clamp 35, so that the molding chamber 17 is formed.

Then, a vacuum valve (not shown) for supplying nitrogen gas is opened, and the vacuum valve 30 for discharging nitrogen gas is also opened. Nitrogen gas is supplied into the molding chamber 17 for 10 seconds.

After that, the vacuum valve (not shown) for supplying nitrogen gas and the vacuum valve 30 for discharging nitrogen gas are closed, and the vacuum valve 31 for vacuum-pumping is opened. As a result, a pressure in the molding chamber 17 starts to be reduced from an atmospheric pressure to a predetermined pressure (6×10⁻¹ Pa) or below. At the same time, the infrared lamp 20 is operated to heat the respective molds 6, 7, 13, and 14, and the glass material 36.

After a temperature of the respective mold members 6, 7, 13, and 14, and the glass material 36 reaches 690° C. (which is higher than a transition point of glass), and the molding chamber 17 is depressurized to 5 Pa, a press-molding is carried out for molding the glass material 36 to an optical element. Conventionally, it takes 35 seconds to depressurize a molding chamber. On the other hand, according to the embodiment using the helical-groove-vacuum pump 37 and the rotary pump 38, it takes only 15 seconds to depressurize the molding chamber to 5 Pa.

After completing the press-molding step, the vacuum valve 31 for vacuum-pumping is closed, while the vacuum pump (not shown) for supplying nitrogen gas is opened to supply nitrogen gas for several seconds. When the pressure in the molding chamber 17 surpasses an atmospheric pressure, the vacuum valve 30 for discharging nitrogen gas is opened to discharge nitrogen gas. The respective mold members 6, 7, 13, and 14, and an optical element thus molded are cooled by means of the flow of nitrogen.

As described above, according to an optical element molding device of the embodiment, a molding chamber is depressurized by a helical-groove-vacuum pump and a rotary pump which are preferably serially connected to each other. Therefore, the molding chamber can be depressurized from an atmospheric pressure to a predetermined pressure in a short time, without switching vacuum-pumping lines as in the conventional device, as well as without damaging a vacuum pump. A conventional switching valve becomes unnecessary, which simplifies a constitution of a vacuum-pump means.

What is claimed is:

1. An optical element molding apparatus comprising:
a sealed molding chamber;
a pair of molds arranged in the molding chamber; and
a vacuum-pump means which vacuum-pumps an inside of the molding chamber; wherein
the vacuum-pump means includes a twist-groove-vacuum pump having a twisted groove on a surface of a rotor which is rotated at a high speed, and a rotary pump; and
the pair of molds are adapted to mold an optical element by press-molding an optical element material which is heated to a temperature higher than a transition point.

2. An optical element molding apparatus according to claim 1, wherein
the twist-groove-vacuum pump and the rotary pump are serially connected to each other.
